(19) United States
(12) Patent Application Publication
(10) Pub. No.: US 2008/0096530 A1
(43) Pub. Date: Apr. 24, 2008

(54) Method for calculating start value for security for user equipment in a wireless communications system and related apparatus

(75) Inventor: Richard Lee-Chee Kuo, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited, Tortola (VG)

(21) Appl. No.: 11/976,049

(22) Filed: Oct. 19, 2007

Related U.S. Application Data
(60) Provisional application No. 60/852,987, filed on Oct. 20, 2006.

(51) Int. Cl. H04M 1/66

(52) U.S. Cl. 455/411

(57) ABSTRACT

In order to enhance data link security, the present invention provides a method of calculating a start value for security for a user equipment, or UE, in a wireless communications system. The method includes selecting ciphering sequence numbers, denoted by COUNT-Cs, and integrity sequence numbers, denoted by COUNT-Is, of radio bearers and signaling radio bearers using the most recently configured ciphering key and integrity key, determining a maximum COUNT value of the selected COUNT-Cs and COUNT-Is and calculating the START value when twenty most significant bits of the maximum COUNT value reach a first value resulting from subtracting a predefined value from a maximum value. Preferably, the maximum value is 1048575, whereas the predefined value is 2 or any other positive integer.

### CROSS REFERENCE TO RELATED APPLICATIONS

This application claims the benefit of U.S. Provisional Application No. 60/852,987, filed on Oct. 20, 2006 and entitled “METHOD AND APPARATUS FOR START VALUE CALCULATION IN A WIRELESS COMMUNICATION SYSTEM”, the contents of which are incorporated herein by reference.

### BACKGROUND OF THE INVENTION

1. Field of the Invention

The present invention relates to a method of calculating a security parameter in a wireless communications system and related communications device, and more particularly to a method of calculating a START value for a user equipment, or UE, in a wireless communications system and related communications device.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates.

For the universal mobile telecommunications system (UMTS), the 3G communications system comprises User Equipment (UE), the UMTS Terrestrial Radio Access Network (UTRAN), and the Core Network (CN). The UE includes mobile equipment (ME) and UMTS subscriber identity module (USIM). The UE wirelessly connects with a Node-B of the UTRAN to exchange information with a radio network controller (RNC). A circuit switched (CS) domain or a packet switched (PS) domain of the CN connects to telecommunications service networks, such as PSTN, ISDN and Internet, to provide various voice and data transmission services. Communications protocols utilized include Access Stratum (AS) and Non-Access Stratum (NAS). AS comprises various sub-layers for different functions, including Radio Resource Control (RRC), Radio Link Control (RLC), Media Access Control (MAC), Packet Data Convergence Protocol (PDCP), and Broadcast/Multicast Control (BMC). The sub-layers mentioned, and their operating principles, are well known in the art, and detailed description thereof is omitted.

Between the user equipment and the network, the RRC layer uses RRC Messages, also known as signaling, to exchange information. RRC Messages are formed from many Information Elements (IE) used for embedding necessary information for setting, changing, or releasing protocol entities of Layer 2 (RLC, MAC) and Layer 1 (Physical Layer), thereby establishing, reconfiguring, or releasing information exchange channels to perform data packet transportation. Through RRC Messages, the RRC layer can embed control signals needed by an upper layer in the RRC Message, which can be sent between the NAS of the user equipment and the CN through the radio interface to complete the required procedures. In addition, from the standpoint of the RRC, all logical data communication exchange channels, be they for providing data transmission exchange to the user or for providing RRC layer control signal transmission exchange, are defined in the context of a Radio Bearer (RB). In the user end, the RB comprises one unidirectional or a pair of uplink/downlink (UL/DL) logic data transmission exchange channels. In the network, the RB comprises one unidirectional or a pair of uplink/downlink logic data transmission exchange channels.

Regarding security of data transfer, the 3^{rd} Generation Partnership Project, 3GPP develops a security architecture specification to provide an Authentication and Key Agreement for use between the UE and the CN. With Authentication and Key Agreement, the UE and the CN can authenticate each other and generate common ciphering keys (CKs) and integrity keys (IK). For the CS domain, the CN and the UE perform the agreement though a visitor location register (VLR) and a home location register (HLR) and thereby generate a CS ciphering key, denoted by CK_{CS}, and a CS integrity key, denoted by IK_{CS}. For the PS domain, the CN and the UE perform the agreement though a serving GPRS support node (SGSN) and an authentication center (AuC) and thereby generate a PS ciphering key, denoted by CK_{PS}, and a PS integrity key, denoted by IK_{PS}. The CK can cipher user plane data, such as service data units (SDUs). Control plane data, such as signaling radio bearers (SRBs) can be ciphered and acquire integrity protection (IP) with the CK and IK, respectively.

To prevent malicious use of the CK and the IK, the said security specification utilizes a START value for controlling lifetime of the CK/IK. Regarding service domains of the CN, the START value can be used in the CS domain or the PS domain, and thereby is known as START_{CS} and START_{PS}. An RRC protocol specification of 3GPP defines several situations where the ME of the UE needs to calculate the START value for hyper-frame-number (HFN) synchronization between the UTRAN and the ME. The situations are as follows:
1. upon initiation of an initial direct transfer;
2. upon establishment of a new radio bearer;
3. upon release of a radio bearer;
4. upon relocation of a serving radio network subsystem (SRNS); and
5. upon release of an RRC connection.
   Besides, according to the RRC protocol specification, Section 8.5.9, an algorithm for calculating the START value for a CN domain during an RRC connection is described below:
Let START_{X}=the START value prior to the calculation, where ‘X’ represents the PS or CS domain of the CN;
START_{X′}=MSB₂₀(MAX{COUNT-C, COUNT-I|radio bearers and signaling radio bearers using the most recently configured CK_{X} and IK_{X}})+2, where MSB₂₀ represents twenty most significant bits;
if START_{X′} is equal to a maximum value STARTmax, then the START value is set to START_{X′};
if START_{X} is less than START_{X′}, then the START value is set to START_{X′}; otherwise the START value is unchanged;
   where COUNT-C is a ciphering sequence number, and COUNT-I is an integrity sequence number. The maximum value STARTmax is 1048575.

The ciphering sequence number COUNT-C is 32 bits long and is composed of a “short” sequence number and a “long” sequence number. The short sequence number forms least significant bits (LSB) of COUNT-C, whereas the long sequence number forms MSBs of COUNT-C. Under an RLC acknowledged mode (AM) or an RLC unacknowledged mode (UM), each uplink RB and each downlink RB has one COUNT-C value. For all transparent mode (TM) RLC radio bearers of the same CN domain, COUNT-C is the same, and COUNT-C is also the same for uplink and downlink. In addition, COUNT-C has different formats under different RLC modes. For example, under the AM mode, the short sequence number is a 12-bit RLC SN, whereas the long sequence number is a 20-bit RLC HFN.

The integrity sequence number COUNT-I is used for providing integrity protection for uplink and downlink SRBs, such as SRB0-SRB4. The integrity sequence number COUNT-I is 32 bits long and is composed of a “short” sequence number and a “long” sequence number. The “short” sequence number forms LSBs of COUNT-I, whereas the “long” sequence number forms MSBs of COUNT-I. The “short” sequence number is a 4-bit RRC SN that is available in each RRC PDU. The “long” sequence number is a 28-bit RRC HFN, which is incremented by 1 at each RRC SN cycle.

The START value is generally stored in the USIM of the UE, and read out each time an RRC connection is established. In addition, upon release of the RRC connection, the current START value (START_{PS} or START_{CS}) is compared with a THRESHOLD value. The THRESHOLD value is configured by the UTRAN and stored in the USIM. If the START value reaches the THRESHOLD value, the START value becomes invalid. The UE then stores the START value in the USIM and deletes the CK and IK, which are also stored in USIM. Furthermore, a key set identifier (KSI) is set to be invalid (i.e. ‘111’) to inform the UTRAN of invalidity of the CK and IK. On the contrary, if the START value has not reached the THRESHOLD value yet, the UE stores the current START value for use in a next RRC connection establishment. At the time of establishment of every RRC connection, the UE will trigger the generation of a new access link key set (a new CK and a new IK) if the current START value has reached the THRESHOLD value, for the corresponding core network domain(s).

In the prior art, the MSB₂₀ of COUNT-C and COUNT-I are the HFNs of corresponding sub-layers, and the HFNs are incremented in a wrap-around manner. That is, the HFNs are started from zero at the next increment as long as the HFNs reach their predefined maximum value. Regarding the above algorithm for START value calculation, if START_{X} is less than STARTmax beforehand, and if COUNT-C and COUNT-I applied to the calculation have been wrapped around one time, START_{X′} will be calculated to be less than START_{X}. As a result, the START value is unchanged, and kept at the value of START_{X}. In this situation, upon release of the RRC connection, the UE will consider CK and IK valid, since the START value is less than the THRESHOLD value, and then store the START value in the USIM. Upon establishment of the next RRC connection, the UE continues using the same CK and IK, whose lifetimes are actually invalidly long, as during last RRC connection. Therefore, the wrap-around of COUNT-C and COUNT-I causes the START value to be calculated to be valid, but actually the START value is invalid. This results in reuse of the same sequence numbers (i.e. COUNT-C and COUNT-I) with the same security key (i.e. IK and CK) as the previous connection, which weakens the data link security.

### SUMMARY OF THE INVENTION

Therefore, the present invention provides a method of calculating start value for a UE in a wireless communications system and related communications device that can effectively control lifetime of the IK and CK to enhance data link security.

The present invention discloses a method of calculating a START value for security for a UE in a wireless communications system. The method includes selecting ciphering sequence numbers, denoted by COUNT-Cs, and integrity sequence numbers, denoted by COUNT-Is, of radio bearers and signaling radio bearers using the most recently configured CK and IK, determining a maximum COUNT value of the selected COUNT-Cs and COUNT-Is and calculating the START value when twenty most significant bits of the maximum COUNT value reach a first value resulting from subtracting a predefined value from a maximum value.

The present invention discloses a communications device of a wireless communications system utilized for properly calculating a START value for security. The communications device includes a control circuit, a central processing unit and a memory. The control circuit is used for realizing functions of the communications device. The central processing unit is installed in the control circuit and used for executing a program code to operate the control circuit. The memory is coupled to the central processing unit and used for storing the program code. The program code includes selecting COUNT-Cs and COUNT-Is of radio bearers and signaling radio bearers using the most recently configured CK and IK, determining a maximum COUNT value of the selected COUNT-Cs and COUNT-Is, and calculating the START value when twenty most significant bits of the maximum COUNT value reach a first value resulting from subtracting a predefined value from a maximum value.

The present invention further discloses a method for data link security enhancement for a UE in a wireless communications system. The method includes calculating a START value for security periodically according to a calculation time. The START value is generated based on COUNT-Cs and COUNT-Is. The calculation time is fixed or configured by a network terminal.

The present invention further discloses a communications device of a wireless communications system utilized for data link security enhancement. The communications device includes a control circuit, a central processing unit and a memory. The control circuit is used for realizing functions of the communications device. The central processing unit is installed in the control circuit and used for executing a program code to operate the control circuit. The memory is coupled to the central processing unit and used for storing the program code. The program code includes calculating a START value for security periodically according to a calculation time. The START value is generated based on COUNT-Cs and COUNT-Is. The calculation time is fixed or configured by a network terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 is a flowchart diagram of a process according to an embodiment of the present invention.

FIG. 4 is a flowchart diagram of a process according to an embodiment of the present invention.

### DETAILED DESCRIPTION

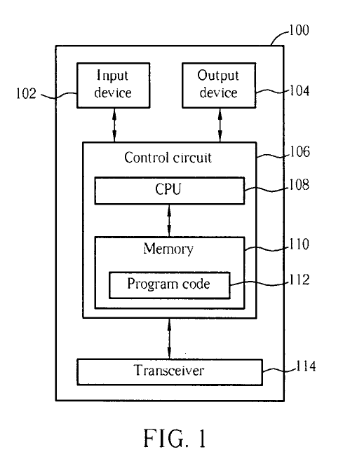

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

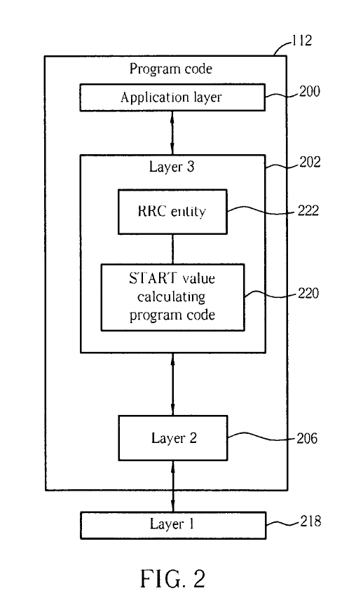

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 includes a radio resource control (RRC) entity 222, which is used for controlling the Layer 1 218 and the Layer 2 206 and performing peer-to-peer RRC communication with other communications devices, such as a base station or a Node-B. The RRC entity 222 mainly utilizes RRC messages and information elements (IEs) to achieve its functions.

In order to maintain secure data transmission, the communications device 100 may utilize an integrity key (IK) and a ciphering key (CK) for ciphering packets, such as service data units (SDUs), or performing both integrity protection and ciphering for control plane data, such as signaling radio bearers (SRBs). If there are no integrity key and ciphering key stored in the communications device 100, the communications device 100 can generate a new integrity key and a new ciphering key through the Authentication and Key Agreement.

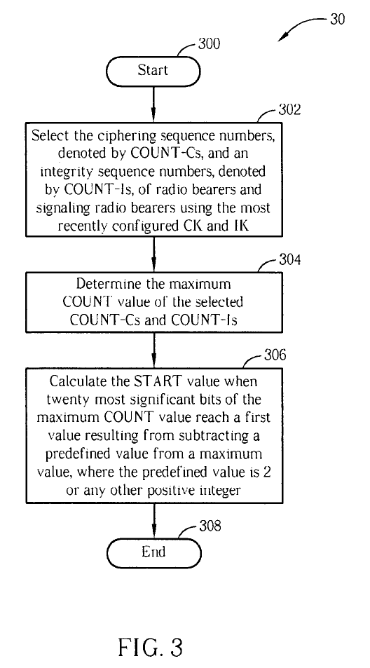

The embodiment of the present invention provides a START value calculating program code 220 to calculate the START value in order to control lifetime of the integrity and ciphering keys. Please refer to FIG. 3, which illustrates a schematic diagram of a process 30 according to an embodiment of the present invention. The process 30 may be utilized for calculating a START value for security for a UE in a wireless communications system, where the START value can be a START_{PS} value or a START_{CS} value. The START_{PS} value represents that the START value is used in a packet switched domain, whereas the START_{CS} value represents that the START value is used in a circuit switched domain. The process 30 can be compiled into the START value calculating program code 220 and includes the following steps:
Step 300: Start.
Step 302: Select the ciphering sequence numbers, denoted by COUNT-Cs, and an integrity sequence numbers, denoted by COUNT-Is, of radio bearers and signaling radio bearers using the most recently configured CK and IK.
Step 304: Determine the maximum COUNT value of the selected COUNT-Cs and COUNT-Is.
Step 306: Calculate the START value when twenty most significant bits of the maximum COUNT value reach a first value resulting from subtracting a predefined value from a maximum value, where the predefined value is 2 or any other positive integer.
Step 308: End.

According to the process 30, COUNT-I consists of a radio resource control sequence number (RRC SN) and an RRC hyper frame number (RRC HFN). COUNT-C is generated based on specific parameters of the radio link control (RLC) layer and has different formats under different RLC modes. For example, under the acknowledged mode (AM), COUNT-C may consist of an RLC sequence number (RLC SN) and an RLC hyper frame number (RLC HFN). In Step 306, the maximum value is preferably 1048575, whereas the first value can be 1048573 or less. When the twenty most significant bits of the maximum COUNT value of the selected COUNT-Cs and COUNT-Is reach the first value which equals to the maximum value minus the predefined value, the START value can be set to the maximum value, which is 1048575. Alternatively, the START value can be calculated based on COUNT-Is and COUNT-Cs with the algorithm disclosed in the abovementioned RRC specification. The calculated START value is then stored in the system. As the next RRC connection is established, the generation of a new access link key set, used for generating new ciphering and integrity keys, will be triggered since the START value reaches the said THRESHOLD value. Thus, the process 30 is mainly utilized to detect wrap-around of COUNT-Is or COUNT-Cs and thereby may determine whether the START value reaches the THRESHOLD value. With the process 30, the system can properly control the lifetime of the ciphering/integrity key to prevent malicious use of the ciphering/integrity key.

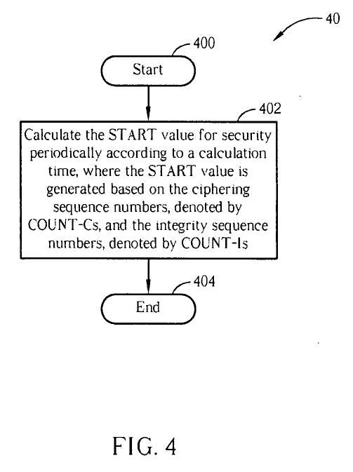

Please refer to FIG. 4, which illustrates a schematic diagram of a process 40 according to an embodiment of the present invention. The process 40 is utilized for calculating a START value for security for a UE in a wireless communications system, where the START value can be a START_{PS} value or a START_{CS} value. The START_{PS} value represents that the START value is used in a packet switched domain, whereas the START_{CS} value represents that the START value is used in a circuit switched domain. The process 40 can be compiled into the START value calculating program code 220 and includes the following steps:
Step 400: Start.
Step 402: Calculate the START value for security periodically according to a calculation time, where the START value is generated based on the ciphering sequence numbers, denoted by COUNT-Cs, and the integrity sequence numbers, denoted by COUNT-Is.
Step 404: End.

According to the process 40, COUNT-I consists of an RRC SN and an RRC HFN. COUNT-C is generated based on specific parameters of the RLC layer and has different formats under different RLC modes. Preferably, the START value for security is calculated periodically according to the algorithm disclosed in the abovementioned RRC specification every calculation time. The calculation time is fixed or configured by a network terminal. Moreover, the START value also needs to be calculated when any of the following events occurs. The events include: (1) upon initiation of an initial direct transfer, (2) upon establishment of a new radio bearer, (3) upon release of a radio bearer, (4) upon relocation of an SRNS, and (5) upon release of an RRC connection. With the process 40, the START value is calculated periodically to increase the probability of detecting the maximum START value, thereby enhancing protection of the corresponding CK and IK.

In conclusion, the processes 30 ensures that the generation of a new access link key set can be triggered at the next RRC connection every time the START value reaches the maximum value (1048575). The process 40 can reduce the probability of missing the maximum START value. Therefore, the embodiments of the present invention can effectively control the lifetime of the CK/IK, thereby preventing malicious use of the CK/IK and enhancing data link security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of calculating a START value for security for a user equipment in a wireless communications system, the method comprising:
selecting ciphering sequence numbers, denoted by COUNT-Cs, and integrity sequence numbers, denoted by COUNT-Is, of radio bearers and signaling radio bearers using the most recently configured ciphering key and integrity key;
determining a maximum COUNT value of the selected COUNT-Cs and COUNT-Is; and
calculating the START value when twenty most significant bits of the maximum COUNT value reach a first value resulting from subtracting a predefined value from a maximum value.

2. The method of claim 1, wherein the START value is a START_{PS} value or a START_{CS} value, where the START_{PS} value represents that the START value is used in a packet switched domain, and the START_{CS} value represents that the START value is used in a circuit switched domain.

3. The method of claim 1, wherein the maximum value is 1048575.

4. The method of claim 1, wherein the predefined value is 2 or any other positive integer.

5. The method of claim 1, wherein calculating the START value when the twenty most significant bits of the maximum COUNT value reach the first value resulting from subtracting a predefined value from a maximum value comprises setting the START value to the maximum value, and the predefined value is 2 or any other positive integer.

6. A communications device used in a communications system for calculating a START value for security, the communications device comprising:
a control circuit for realizing functions of the communications device;
a central processing unit coupled to the control circuit for executing a program code to operate the control circuit; and
a memory coupled to the central processing unit for storing the program code;
wherein the program code comprises:
selecting ciphering sequence numbers, denoted by COUNT-Cs, and integrity sequence numbers, denoted by COUNT-Is, of radio bearers and signaling radio bearers using the most recently configured ciphering key and integrity key;
determining a maximum COUNT value of the selected COUNT-Cs and COUNT-Is; and
calculating the START value when twenty most significant bits of the maximum COUNT value reach a first value resulting from subtracting a predefined value from a maximum value.

7. The communications device of claim 6, wherein the START value is a START_{PS} value or a START_{CS} value, where the START_{PS} value represents that the START value is used in a packet switched domain, and the START_{CS} value represents that the START value is used in a circuit switched domain.

8. The communications device of claim 6, wherein the maximum value is 1048575.

9. The communications device of claim 6, wherein the predefined value is 2 or any other positive integer.

10. The communications device of claim 6, wherein calculating the START value when the twenty most significant bits of the maximum COUNT value reach the first value resulting from subtracting a predefined value from a maximum value comprises setting the START value to the maximum value, and the predefined value is 2 or any other positive integer.

11. A method for data link security enhancement for a user equipment in a wireless communications system, the method comprising:
calculating a START value for security periodically according to a calculation time, the START value generated based on a plurality of ciphering sequence numbers, denoted by COUNT-Cs, and a plurality of integrity sequence numbers, denoted by COUNT-is, the calculation time fixed or configured by a network terminal.

12. The method of claim 11, wherein the START value is a START_{PS} value or a START_{CS} value, where the START_{PS} value represents that the START value is used in a packet switched domain, and the START_{CS} value represents that the START value is used in a circuit switched domain.

13. The method of claim 11 further comprising calculating the START value when any of a plurality of events occurs, the plurality of events comprising:
initiation of an initial direct transfer;
establishment of a new radio bearer;
release of a radio bearer;
relocation of a serving radio network subsystem, abbreviated to SRNS; and
release of a radio resource control, abbreviated to RRC, connection.

14. A communications device used in a communications system for data link security enhancement, the communications device comprising:
a control circuit for realizing functions of the communications device;
a central processing unit coupled to the control circuit for executing a program code to operate the control circuit; and
a memory coupled to the central processing unit for storing the program code;
wherein the program code comprises:
calculating a START value for security periodically according to a calculation time, the START value generated based on a plurality of ciphering sequence numbers, denoted by COUNT-Cs, and a plurality of integrity sequence numbers, denoted by COUNT-is, the calculation time fixed or configured by a network terminal.

15. The communications device of claim 14, wherein the START value is a START_{PS} value or a START_{CS} value, where the START_{PS} value represents that the START value is used in a packet switched domain, and the START_{CS} value represents that the START value is used in a circuit switched domain.

16. The communications device of claim 14 further comprising calculating the START value when any of a plurality of events occurs, the plurality of events comprising:
initiation of an initial direct transfer;
establishment of a new radio bearer;
release of a radio bearer;
relocation of a serving radio network subsystem, abbreviated to SRNS; and
release of a radio resource control, abbreviated to RRC, connection.
